(19) United States
(12) Patent Application Publication
(10) Pub. No.: US 2023/0419712 A1
(43) Pub. Date: Dec. 28, 2023

(54) IMAGE PROCESSING APPARATUS, IMAGE PROCESSING METHOD, AND STORAGE MEDIUM

(71) Applicant: NEC Corporation, Tokyo (JP)

(72) Inventor: Junya AKIYAMA, Tokyo (JP)

(73) Assignee: NEC Corporation, Tokyo (JP)

(21) Appl. No.: 18/213,978

(22) Filed: Jun. 26, 2023

(30) Foreign Application Priority Data
Jun. 28, 2022 (JP) 2022-108930

(51) Int. Cl. G06V 30/414; G06V 30/412

(52) U.S. Cl. CPC G06V 30/414; G06V 30/412

(57) ABSTRACT

An image processing apparatus includes: a reading section that refers to a reference image to read entered information from an input image or a partial image, the reference image representing a blank entry column, the input image representing a target form that contains an entry column, the partial image representing the entry column; a generating section that refers to a group of partial images to generate a new reference image, the group of partial images having the partial image added thereto, the new reference image representing a blank entry column; and an updating section that replaces the reference image with the new reference image, in order to allow, without advance preparation of a plurality of forms, more accurate reading of the entered information having been entered in a form.

This Nonprovisional application claims priority under U.S.C. § 119 on Patent Application No. 2022-103930 filed in Japan on Jun. 28, 2022, the entire contents of which are hereby incorporated by reference.

### TECHNICAL FIELD

The present invention relates to an image processing apparatus, an image processing method, and a storage medium.

### BACKGROUND ART

Techniques for recognizing characters written in a form such as a ledger sheet have been proposed. For example, Patent Literature 1 discloses a method of acquiring entry field information on the basis of a difference portion obtained by matching the image data of a blank survey sheet against the image data of a survey sheet in which specific symbols are written. Further, Patent Literature 2 discloses generating the image data of a difference between a first image data of a ledger sheet in which information has not been entered yet in a predetermined read target region and a second image data of a ledger sheet in which information has been entered in the read target region, to recognize information having been entered in the ledger sheet with use of the image data of the difference. Furthermore, Patent Literature 3 discloses a technique of using a plurality of written ledger sheets to generate image data representing a blank ledger sheet.

### CITATION LIST

### Patent Literature

[Patent Literature 1]
Japanese Patent Application Publication, Tokukai, No. 2011-134080

[Patent Literature 2]
Japanese Patent Application Publication, Tokukai, No. 2016-53875

[Patent Literature 3]
Japanese Patent Application Publication, Tokukai, No. 2020-140323

### SUMMARY OF INVENTION

### Technical Problem

The techniques disclosed in Patent Literatures 1 and 2 require advance preparation of a black ledger sheet. Thus, there is a problem of being incapable of using the techniques in the absence of a blank ledger sheet. Further, the technique disclosed in Patent Literature 3 requires advance preparation of a plurality of written ledger sheets. Thus, there is a problem of being incapable of using the technique in the absence of a plurality of ledger sheets.

An aspect of the present invention has been made in view of the above problems, and an example object thereof is to provide a technique for allowing more accurate reading of entered information having been entered in a form without advance preparation of a plurality of forms.

### Solution to Problem

An image processing apparatus in accordance with an aspect of the present invention includes at least one processor, the at least one processor carrying out: processing of referring to a reference image to read entered information from an input image or a partial image, the reference image representing a blank entry column, the input image representing a target form that contains an entry column, the partial image representing the entry column; processing of referring to a group of partial images to generate a new reference image, the group of partial images having the partial image added thereto, the new reference image representing a blank entry column; and processing of replacing the reference image with the new reference image for update.

An image processing method in accordance with an aspect of the present invention includes: at least one processor referring to a reference image to read entered information from an input image or a partial image, the reference image representing a blank entry column, the input image representing a target form that contains an entry column, the partial image representing the entry column; the at least one processor referring to a group of partial images to generate a new reference image, the group of partial images having the partial image added thereto, the new reference image representing a blank entry column; and the at least one processor replacing the reference image with the new reference image.

A non-transitory storage medium in accordance with an aspect of the present invention stores an image processing program for causing a computer to carry out: processing of referring to a reference image to read entered information from an input image or a partial image, the reference image representing a blank entry column, the input image representing a target form that contains an entry column, the partial image representing the entry column; processing of referring to a group of partial images to generate a new reference image, the group of partial images having the partial image added thereto, the new reference image representing a blank entry column; and processing of replacing the reference image with the new reference image for update.

### Advantageous Effects of Invention

With an aspect of the present invention, it is possible to more accurately read entered information having been entered in a form without preparing in advance a plurality of forms.

### BRIEF DESCRIPTION OF DRAWINGS

FIG. 1 is a block diagram of a configuration of an image processing apparatus in accordance with a first example embodiment.

FIG. 2 is a flowchart of an image processing method in accordance with the first example embodiment.

FIG. 3 is a block diagram of a configuration of an image processing apparatus in accordance with a second example embodiment.

FIG. 4 is a diagram of a specific example of a form in accordance with the second example embodiment.

FIG. 5 is a flowchart of processing, in accordance with the second example embodiment, of setting format information.

FIG. 6 is a flowchart of processing, in accordance with the second example embodiment, of reading entered information.

FIG. 7 is a block diagram of a configuration of an image processing apparatus in accordance with a third example embodiment.

FIG. 8 is a flowchart of processing, in accordance with the third example embodiment, of reading entered information.

FIG. 9 is a diagram of an example of a computer that executes the instructions of a program that is software for implementing the functions of each of the apparatuses of the respective example embodiments of the present invention.

### EXAMPLE EMBODIMENTS

### First Example Embodiment

The following description will discuss a first example embodiment of the present invention in detail, with reference to the drawings. The first example embodiment is basic to the example embodiments that will be described later.

(Configuration of Image Processing Apparatus)

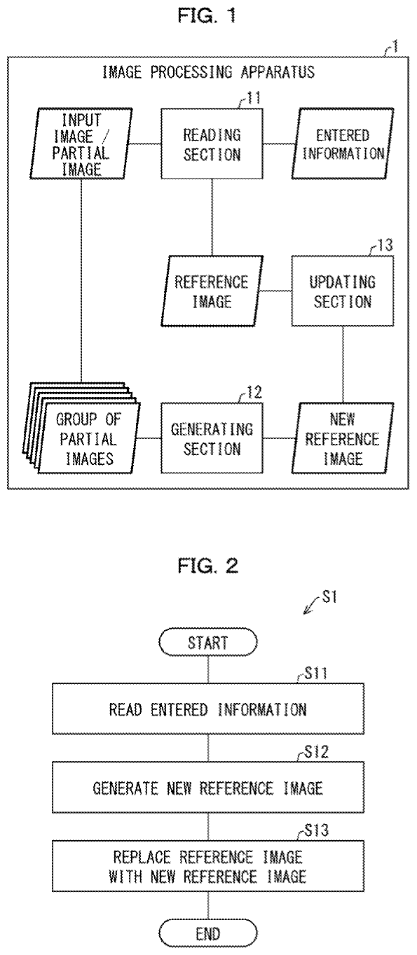

The configuration of an image processing apparatus 1 in accordance with the first example embodiment will be described below, with reference to FIG. 1. FIG. 1 is a block diagram of a configuration of the image processing apparatus 1. The image processing apparatus 1 includes a reading section 11, a generating section 12, and an updating section 13. In FIG. 1, each of the rhombus-shaped blocks represents data. The reading section 11 refers to a reference image representing a blank entry column, to read entered information from an input image representing a target form that contains an entry column or a partial image representing the entry column. The generating section 12 refers to a group of partial images having the partial image added thereto, to generate a new reference image representing a blank entry column. The updating section 13 replaces the reference image with the new reference image.

As above, a configuration employed in the image processing apparatus 1 in accordance with the first example embodiment is that the image processing apparatus 1 includes: a reading section 11 that refers to a reference image representing a blank entry column, to read entered information from an input image representing a target form that contains an entry column or a partial image representing the entry column; a generating section 12 that refers to a group of partial images having the partial image added thereto, to generate a new reference image representing a blank entry column; and an updating section 13 that replaces the reference image with the new reference image. Accordingly, the image processing apparatus 1 in accordance with the first example embodiment provides an example advantage of being capable of more accurately reading entered information having been entered in a form without preparing in advance a plurality of forms.

(Image Processing Program)

The above functions of the image processing apparatus 1 can be implemented via a program. An image processing program in accordance with the first example embodiment causes a computer to function as: a reading means for referring to a reference image representing a blank entry column, to read entered information from an input image representing a target form that contains an entry column or a partial image representing the entry column; a generating means for referring to a group of partial images having the partial image added thereto, to generate a new reference image representing a blank entry column; and an updating means for replacing the reference image with the new reference image.

(Process Flow of Image Processing Method)

The process flow of an image processing method S1 in accordance with the first example embodiment will be described with reference to FIG. 2. FIG. 2 is a flowchart of the image processing method S1. Each of the steps of the image processing method S1 may be carried out by a processor included in the image processing apparatus 1 or a processor included in another apparatus. Alternatively, the steps may be carried out by respective processors provided in different apparatuses.

In step S11, at least one processor refers to a reference image representing a blank entry column to read entered information from an input image representing a target form that contains an entry column or a partial image representing the entry column. In step S12, the at least one processor refers to a group of partial images having the partial image added thereto, to generate a new reference image representing a blank entry column. In step S13, the at least one processor replaces the reference image with the new reference image.

As above, a configuration employed in the image processing method S1 in accordance with the first example embodiment is that the image processing method S1 includes the steps of: at least one processor referring to a reference image representing a blank entry column to read entered information from an input image representing a target form that contains an entry column or a partial image representing the entry column; the at least one processor referring to a group of partial images having the partial image added thereto, to generate a new reference image representing a blank entry column; and the at least one processor replacing the reference image with the new reference image. Accordingly, the image processing method S1 in accordance with the first example embodiment provides an example advantage of being capable of more accurately reading entered information having been entered in a form without preparing in advance a plurality of forms.

### Second Example Embodiment

The following description will discuss a second example embodiment of the present invention in detail, with reference to the drawings. The same reference sign is assigned to a component that has the same function as the component described in the first example embodiment, and the description thereof is not repeated.

<Configuration of Image Processing Apparatus>

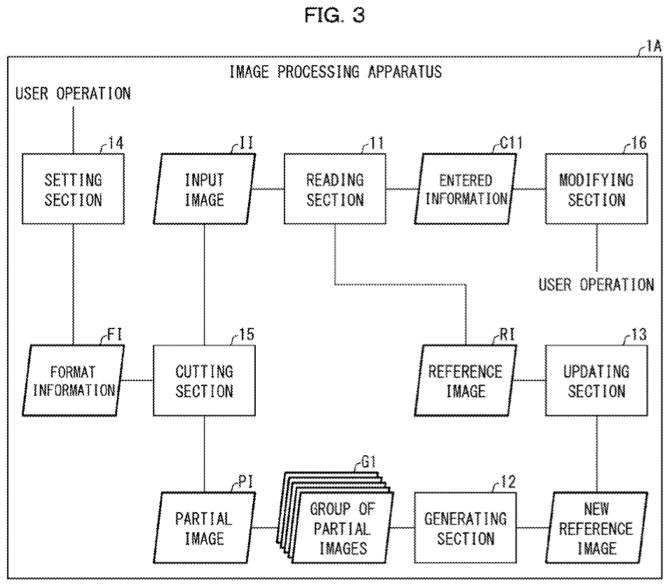

FIG. 3 is a block diagram of a configuration of an image processing apparatus 1A in accordance with a second example embodiment. The image processing apparatus 1A includes a reading section 11, a generating section 12, an updating section 13, a setting section 14, a cutting section 15, and a modifying section 16.

(Reading Section)

The reading section 11 refers to a reference image RI representing a blank entry column to read entered information C11 from an input image II representing a form that contains an entry column or a partial image PI representing the entry column.

(Form⋅Entry Column⋅Entered Information)

The form is a medium that contains at least one entry column. Examples of the form include a ledger sheet. The form may be, for example, a piece of paper, or may be a sheet made of a material other than paper, such as an OHP sheet. The entry column is a column in which to write a character such as a letter. Examples of the entry column include a column in which to enter a zip code and a column in which to enter a name. The entered information C11 is information entered by a user in the entry column. Examples of the entered information C11 include: a string, entered by a user, of characters such as a number and an alphabet; and the signature of the user.

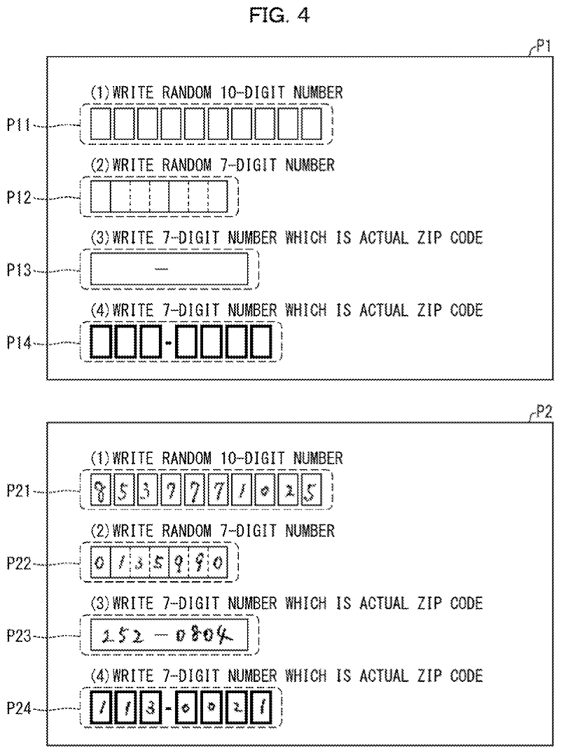

FIG. 4 is a diagram of an example of the form. In FIG. 4, a form P1 contains entry columns P11 to P14. Further, a form P2 contains entry columns P21 to P24. The entry columns P11 and P21 are columns in which to write a 10-digit number. The entry columns P12 and P22 are columns in which to write a 7-digit number. The entry columns P13, P14, P23, and P24 are columns in which to write 7-digit number which is a zip code. The entry columns P11 to P14 are blank entry columns, whereas the entry columns P21 to P24 are entry columns having been filled in.

(Input Image)

The input image II is an image representing a form. Examples of the input image II include an image obtained by subjecting the form to reading carried out by an image reading apparatus. For example, the image reading apparatus generates image data (e.g., bitmap data) representing a form by detecting light reflected from the form with use of an image sensor. The form represented by the input image II is an example of the “target form” in accordance with this specification.

(Generating Section)

The generating section 12 refers to a group of partial images G1 having added thereto the partial image PI, from which the reading section 11 reads the entered information C11, to generate a new reference image representing a blank entry column. Details of processing of the generation by the generating section 12 will be described later.

(Updating Section)

The updating section 13 updates the reference image RI by replacing the reference image RI with the new reference image generated by the generating section 12.

(Setting Section⋅Format Information)

The setting section 14 carries out processing of setting format information FI regarding the entry column, according to a user operation. For example, the format information FI include information that indicates the coordinates of each entry column and the type of character (a number, an alphabet, etc.) to be written in each entry column. However, the format information FI is not limited to information set by a user, but may, for example, be stored in predetermined storage in advance. The format information FI is stored for each format of a form, and is referred to when the reading section 11 reads entered information from a form.

(Cutting Section⋅Modifying Section)

The cutting section 15 carries out processing of referring to the format information FI to cut out the partial image PI from the input image II. The modifying section 16 modifies the entered information C11 according to a user operation.

<Process Flow of Image Processing Method>

In broad terms, the image processing apparatus 1A carries out processing (i) of setting the format information FI and processing (ii) of reading the entered information C11. The processing (i) of setting the format information FI is processing of the image processing apparatus 1A setting the format information FI. The processing (ii) of reading the entered information C11 is processing of the image processing apparatus 1A using the format information FI set in the processing of setting the format information FI, to read the entered information C11 having been entered in a form.

In a case where multiple forms are subjected to reading, the image processing apparatus 1A carries out both the processing (i) and the processing (ii) with respect to the first form. With respect to the second and subsequent forms, the image processing apparatus 1A carries out only the processing (ii). Further, in a case where only one form is subjected to reading, the image processing apparatus 1A carries out both the processing (i) and the processing (ii) with respect to that only one form. Each of the processing (i) and the processing (ii) will be described below with reference to the drawings.

(Processing (i) of Setting Format Information)

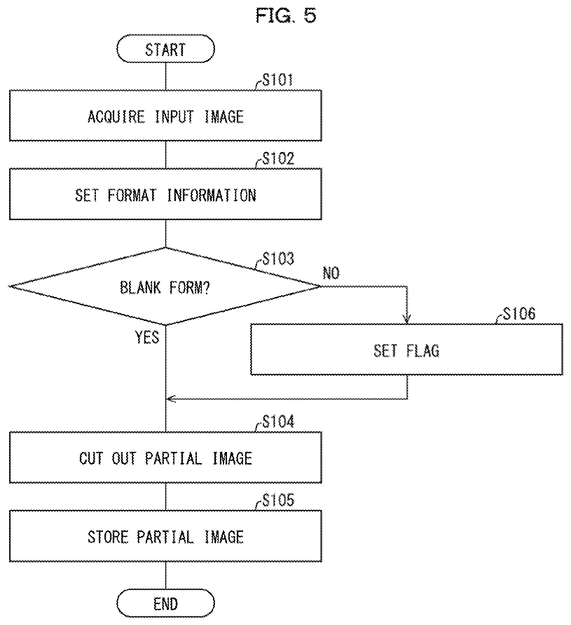

FIG. 5 is a flowchart of processing, carried out by the image processing apparatus 1A, of setting format information.

(Step S101)

In step S101, the setting section 14 acquires the input image II representing the first form. The first form may be a blank form, or may be a written form. For example, the setting section 14 acquires the input image II from an image reading apparatus connected to an input-output IF (not illustrated). Alternatively, the setting section 14 may acquire the input image II from another apparatus connected via a communication IF (not illustrated).

(Step S102)

In step S102, the setting section 14 carries out processing of setting format information regarding an entry column, according to a user operation. More specifically, for example, a user uses input equipment, such as a touch panel, connected to the input-output IF to carry out an operation of inputting format information corresponding to the input image II acquired in step S101. In addition, the setting section 14 stores format information FI in storage (not illustrated) in accordance with information inputted through the input equipment.

(Step S103)

In step S103, the setting section 14 determines whether the input image II acquired in step S101 is the image of a blank form or the image of a written form. For example, the setting section 14 carries out processing of this determination according to a user operation of selecting whether the input image is a blank form. In a case where the input image II is the image of a blank form (YES in step S103), the setting section 14 proceeds to processing of step S104. In a case where the input image II is the image of a written form (NO in step S103), the setting section 14 proceeds to processing of step S106.

(Step S104)

In step S104, the cutting section 15 refers to the format information set in step S102 to carry out processing of cutting out, from the input image II, the partial image PI representing each of the entry columns. For example, the cutting section 15 refers to the coordinates of each of the entry columns contained the format information FI, to cut out the image of that entry column. More specifically, for example, in a case where the input image II is the image of the form P1 illustrated in FIG. 4, the cutting section 15 carries out processing of cutting out the image of each of the entry columns P11 to P14, the image being the partial image PI. In a case where the input image II is the image of the form P2 illustrated in FIG. 4, the cutting section 15 carries out processing of cutting out the image of each of the entry columns P21 to P24, the image being the partial image PI.

(Step S105)

In step S105, the cutting section 15 stores, in predetermined storage, the partial image PI having been cut out, which is the reference image RI.

(Step S106)

In step S106, the setting section 14 sets the value of a flag to “1”. This flag indicates whether the reference image RI is the image of an entry column having been filled in. In a case where the value of the flag is “1”, the reference image RI is the image of an entry column having been filled in. In a case where the value of the flag is “0”, the reference image RI is the image of a blank entry column. This flag is referred to by the modifying section 16 in processing (described later) of reading the entered information C11. The flag may be set for each form, or may be set for each entry column.

(Processing (ii) of Reading Entered Information)

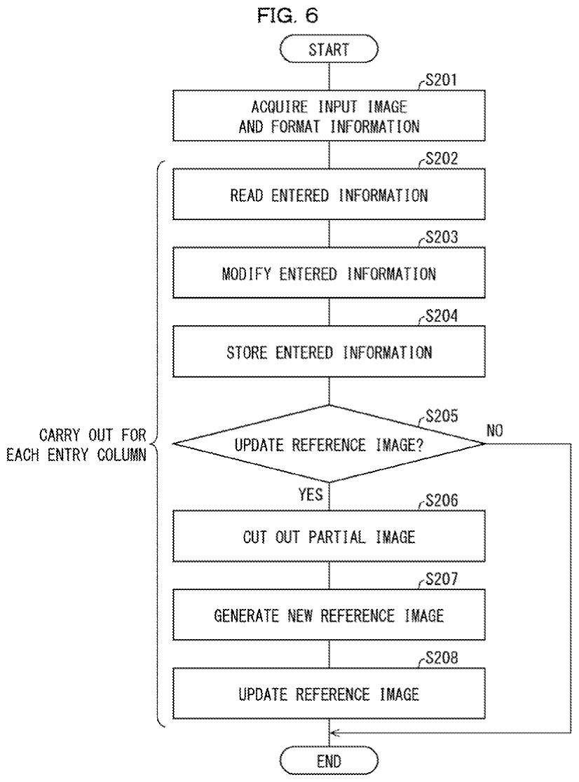

FIG. 6 is a flowchart of processing, carried out by the image processing apparatus 1A, of reading the entered information C11. The image processing apparatus 1A may carry out the processing illustrated in FIG. 6 on a form-by-form basis, every predetermined number of forms, or every time a predetermined amount of time passes.

(Step S201)

In step S201, the reading section 11 acquires the input image II representing a form and the format information FI corresponding to the form represented by the input image II. For example, the reading section 11 may read the input image II and/or the format information FI from storage incorporated in or externally connected to the image processing apparatus 1A, or may receive the input image II and/or the format information FI from another apparatus connected via the communication IF. Alternatively, the reading section 11 may acquire the input image II and/or the format information FI that is/are inputted via input equipment connected to the input-output IF.

(Step S202)

Processing of each of steps S202 to S208 illustrated in FIG. 6 is carried out for each of the entry columns contained in a form. In step S202, the reading section 11 refers to the reference image RI of an entry column subjected to reading, to carry out processing of reading the entered information C11 from the input image II acquired in step S201 or the partial image contained in the input image II. As the processing of the reading section 11 reading the entered information C11, a conventional character recognition method such as, for example, an optical character reader (OCR) is used.

In the processing of step S202, as the image representing a blank entry column, the reference image RI is referred to by the reading section 11. More specifically, for example, the reading section 11 refers to the difference between the reference image RI and a partial image contained in the input image II, to read the entered information C11.

In a case where a form subjected to the processing is the first form and is a written form, the reference image RI is an image stored in the storage in step S105 illustrated in FIG. 5. In this case, the reference image RI is not an image representing a blank entry column, but an image representing an entry column having been filled in.

(Step S203)

In step S203, the modifying section 16 presents the result of the reading to a user, to modify the entered information C11 according to a user operation. For example, the modifying section 16 outputs the read result to output equipment such as a display. The user check the read result outputted, and carries out an operation of modifying the read result. The modifying section 16 modifies the entered information C11 in accordance with information inputted via the input equipment operated by the user.

(Step S204)

In step S204, the modifying section 16 stores, in the storage, the entered information C11 having been modified.

(Step S205)

In step S205, the modifying section 16 determines whether to update the reference image RI. For example, in a case where the value of a flag corresponding to the reference image RI referred to in step S202 is “1”, the modifying section 16 determines that the reference image RI is to be updated. In a case where the value of the flag corresponding to the reference image RI referred to in step S202 is “0”, the modifying section 16 determines that the reference image RI is not to be updated. In a case where the reference image is to be updated (YES in step S205), the modifying section 16 proceeds to processing of step S206. In a case where the reference image RI is not to be updated, the modifying section 16 ends the process illustrated in FIG. 6.

(Step S206)

In step S206, the cutting section 15 carries out processing of cutting out the partial image PI from the input image II. For example, the cutting section 15 refers to the format information FI corresponding to the input image II, to carry out the processing of cutting out the partial image PI in accordance with the coordinates of an entry column contained in the format information.

(Step S207)

In step S207, the generating section 12 add, to the group of partial images G1, the partial image PI cut out in step S206 and refers to the group of partial images G1 having added thereto the partial image PI, to generate a new reference image.

As an example of the processing of generating the new reference image, the generating section 12 may generate the new reference image in accordance with the result of statistical processing, carried out for each pixel, of the pixel values of the partial images. More specifically, for example, the generating section 12 may compile the pixel values for each pixel to generate the new reference image in which the most frequent pixel value is adopted for each pixel.

As another example of the processing of generating the new reference image, the generating section 12 may select, as the new reference image, one image from among a plurality of partial images included in the group of partial images G1. More specifically, for example, the generating section 12 may select, as the new reference image, an image the pixel value variance of which is the smallest or an image the average pixel value of which is the closest to the background color of a ledger sheet.

As still another example, in a case where the number of partial images included in the group of partial images G1 is equal to or greater than a predetermined threshold, the generating section 12 may generate the new reference image with use of a generative model such as an autoencoder or a generative adversarial network (GAN). In this case, the input of the generative model includes, for example, the group of partial images G1, and the output of the generative model includes, for example, the new reference image. However, the method by which the generating section 12 generates the new reference image is not limited to the examples above, but the generating section 12 may generate the new reference image by another method.

(Step S208)

In step S208, the updating section 13 updates the reference image RI by replacing the reference image RI with the new reference image generated in step S207.

The processing of steps S206 to S208 are carried out in a case where the value of the flag is “1”. In other words, in steps S206 to S208, depending on whether a first input image of a series of input images, the first input image being an initial input image of the series of input images, represents a written form or a blank form, the series of input images that represent forms of the same format, each of the cutting section 15, the generating section 12, and the updating section 13 determines whether to carry out the above corresponding processing with respect to a second and subsequent images that included in the series of input images and that follow the first input image.

Although the modifying section 16 determines whether to update the reference image RI according to the value of the flag in the processing illustrated in FIG. 6, the method for determining whether to update the reference image RI is not limited to the above example. For example, in a case where a predetermined condition is met, the modifying section 16 may determine that the reference image RI is to be updated. The predetermined condition may be such a condition that an update of the reference image is instructed through a user operation, or may be a such a condition that an update of the reference image is selected through, for example, estimation made with use of a trained model generated by machine learning. Further, for example, the modifying section 16 may refer to both the above flag and the instructions provided through a user operation, to carry out the above determination. In other words, the modifying section 16 may refer to at least one of the following items (i) to (iii) to carry out the above determination: (i) the flag; (ii) the instructions provided though a user operation; and (iii) the result of an estimation made with use of the trained model.

<Example Advantage of Image Processing Apparatus>

As above, in the image processing apparatus 1A in accordance with the second example embodiment, in a case where the first form subjected to reading is a written form, the reading section 11 refers to the reference image RI stored in step S105 illustrated in FIG. 5, to read the entered information C11, in step S202 illustrated in FIG. 6. Accordingly, even in a case where a plurality of forms are not prepared (case where only one form is subjected to reading), it is possible for the reading section 11 to carry out the processing of reading the entered information C11 having been entered in a form. Further, each time the reading section 11 carries out the processing of reading the entered information C11 (step S202 illustrated in FIG. 6), the updating section 13 carries out the processing of updating the reference image RI (step S208 illustrated in FIG. 6). The updating section 13 keeps the reference image RI updated. This allow more accurate reading of the entered information C11 having been entered in a form.

A configuration employed in the image processing apparatus 1A in accordance with the second example embodiment is that the image processing apparatus 1A includes: a setting section 14 that carries out, according to a user operation, processing of setting format information FI regarding an entry column; and a cutting section 15 that refers to the format information FI to carry out processing of cutting out a partial image PI from the input image II. Accordingly, the image processing apparatus 1A in accordance with the second example embodiment provides an example advantage of being capable of reading the entered information C11 having been entered in the entry column the format information of which is set according to a user operation, without advance preparation of a plurality of forms and with greater accuracy.

Another configuration employed in the image processing apparatus 1A in accordance with the second example embodiment is that depending on whether a first input image of a series of input images, the first input image being an initial input image of the series of input images, represents a written form or a blank form, the series of input images that represent forms which are of the same format as the form, each of the cutting section 15, the generating section 12, and the updating section 13 determines whether to carry out the above corresponding processing with respect to a second and subsequent images that included in the series of input images and that follow the first input image. Accordingly, the image processing apparatus 1A in accordance with the second example embodiment provides an example advantage of being capable of more accurately reading entered information having been entered in a form without preparing in advance a plurality of forms.

### Third Example Embodiment

The following description will discuss a third example embodiment of the present invention in detail, with reference to the drawings. The same reference sign is assigned to a component that has the same function as the component described in the first example embodiment, and the description thereof is not repeated.

<Functional Configuration of Image Processing Apparatus>

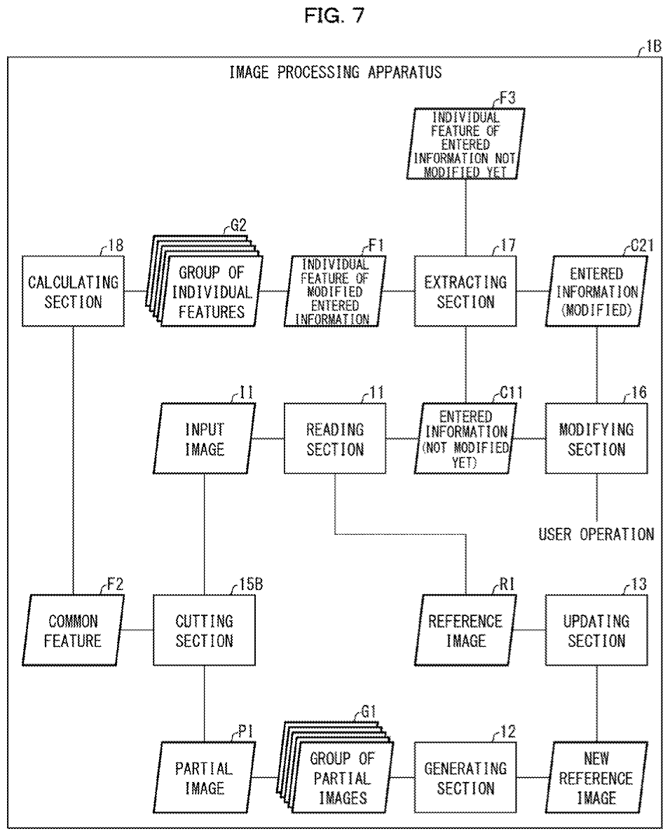

FIG. 7 is a block diagram of an example of a functional configuration of an image processing apparatus 1B in accordance with a third example embodiment. The image processing apparatus 1B includes an extracting section 17, a calculating section 18, and a cutting section 15B, in addition to the reading section 11, the generating section 12, the updating section 13, and the modifying section 16.

The extracting section 17 extracts an individual feature FA, which is a feature regarding entered information C21 having been modified, from the entered information C21. The feature regarding the entered information C21 is information corresponding to the format information of the second example embodiment, and includes, for example, the position, the size, the type of character, the size of letter, or the degree of proximity of letters of entered information.

The calculating section 18 refers to a group of individual features G2 having an individual feature F1 added thereto, to calculate a common feature F2, which is the feature of information to be entered into a form which is of the same format as the form represented by the input image II. The cutting section 15B refers to the common feature F2 to cut out the partial image PI from the input image II.

In the third example embodiment, for example, each of the modifying section 16, the extracting section 17, the calculating section 18, and the cutting section 15B may determine whether to carry out the above corresponding processing, according to a similarity between an individual feature F3 regarding the entered information read by the reading section 11 and the common feature F2. As used herein, the phrase “the common feature F2 matches the individual feature F3” means that the difference between these features is sufficiently small (the difference falls within an allowable range).

In this case, for example, the reading section 11 carries out character recognition processing or the like with respect to the entire image representing a form to identify at least one candidate region of an entry column, and extracts at least one individual feature F3 regarding the at least one candidate region identified. Further, the reading section 11 determines whether to update the common feature F2 (whether to cause each of the modifying section 16, the extracting section 17, the calculating section 18, and the cutting section 15B to carry out the above corresponding processing) in accordance with the result of comparison between the common feature F2 and the at least one individual feature F3 extracted. For example, as to the individual feature F3 the difference from the common feature F2 of which is the smallest of a plurality of individual features F3 extracted, in a case where the difference falls outside the allowable range, the reading section 11 causes each of the modifying section 16, the extracting section 17, the calculating section 18, and the cutting section 15B to carry out the above corresponding processing.

Specifically, for example, in a case where the common feature F2 of an entry column of “money amount” is {position, size, type of character}={upper right part of form, height 10 mm to 15 mm, number 3 digits to 5 digits}, the reading section 11 carries out character recognition processing or the like with respect to a form to extract a plurality of candidate regions of the entry column of “money amount” in a certain input image, and determines whether the difference between the individual feature F3 of each of the candidate regions extracted and the common feature F2 falls within the allowable range. In this case, acceptable extents such as a slight difference in the height or the position and a reduced number of the digits shall be defined in advance. A case where the difference falls outside the allowable range is, for example, the case where a hiragana character is contained in an entry despite the fact that the entry should be filled with a numeric character alone. In a case where the difference falls outside the allowable range, each of the modifying section 16, the extracting section 17, the calculating section 18, and the cutting section 15B carries out the above corresponding processing.

<Process Flow of Image Processing Method>

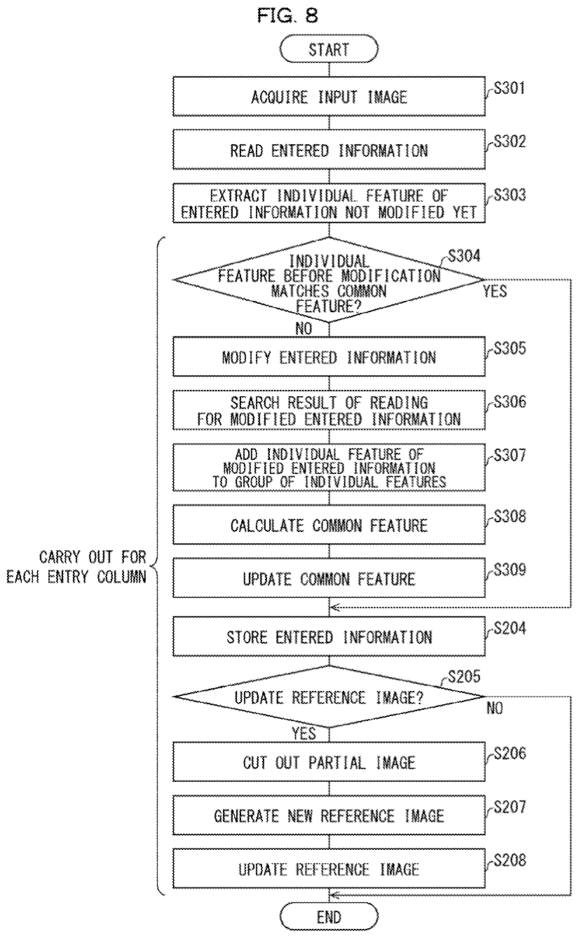

FIG. 8 is a flowchart of an example of processing, carried out by the image processing apparatus 1B, of reading the entered information C11. The image processing apparatus 1B may carry out the processing illustrated in FIG. 8 on a form-by-form basis, every predetermined number of forms, or every time a predetermined amount of time passes. In the above processing, in accordance with the second example embodiment, illustrated in FIG. 6, the image processing apparatus 1A uses format information inputted by a user in advance, to carry out the processing of reading entered information. In contrast, in the processing illustrated in FIG. 8, the format information is not inputted in advance, and the image processing apparatus 1B calculates the common feature corresponding to format information.

(Step S301)

In step S301, the reading section 11 acquires an input image II representing a form.

(Step S302)

In step S302, the reading section 11 carries out processing of reading entered information C11 from the entire input image II representing a form. The reading section 11 uses a conventional character recognition method, such as OCR, to read the entered information from the form. In the processing of step S302, the reading section 11 refers to the reference image RI of each of entry columns, the reference image RI being an image representing a blank entry column, to read the entered information C11. In step S302, the reading section 11 reads, from the input image II, the entered information C11 in each of the plurality of candidate regions.

(Step S303)

In step S303, the extracting section 17 extracts, from the plurality of pieces of entered information C11 that have not been modified yet, the respective individual features.

(Step S304)

Processing of step S304 and the subsequent steps (processing of steps S304 to S208) is carried out for each of the entry columns contained in the form. In step S304, the extracting section 17 determines whether, among the plurality of pieces of entered information C11 that have not been modified yet, there is the entered information C11 the individual feature F3 of which matches the common feature F2 of the entry column subjected to the reading. In a case where there is the entered information C11 the individual feature F3 of which matches the common feature F2 (YES in step S304), the extracting section 17 skips processing of steps S305 to S309 (processing of updating the common feature F2) and proceeds to the processing of step S204. In a case where there is not the entered information C11 the individual feature F3 of which matches the common feature F2 (NO in step S304), the extracting section 17 proceeds to processing of step S305.

Incidentally, in a case of the first form, the common feature F2 of each entry column is not stored. In this case, the extracting section 17 may use a predetermined default value as the common feature F2 of each entry column in step S304, or may determine that the individual feature F3 does not matches the common feature and proceed to processing of step S305.

(Step S305)

In step S305, the modifying section 16 outputs, on the output equipment such as a display, connected to the input-output IF, a message that prompts the user to enter correct information, and modifies the entered information C11 according to the user operation. More specifically, for example, the modifying section 16 outputs, to the output equipment such as display, a message indicating the reading of the entry column failed. After seeing the message outputted, the user inputs correct information to be entered. The modifying section 16 modifies the entered information C11 in accordance with information inputted via the input equipment operated by the user.

The modification to the entered information C11 may be carried out in accordance with the information inputted in advance by the user. For example, in some cases, in storing an input image obtained by subjecting a contract to reading, information (money amount) to be entered in an entry column in which to enter the money amount to be contained in the contract needs to be inputted by a user in advance. In these cases, the modifying section 16 acquires entered information inputted by the user in advance.

(Step S306)

In step S306, the extracting section 17 searches the result of the reading carried out in step S302 for the entered information C21 (the entered information inputted by the user) that has been modified. In this respect, in a case where entered information is inputted by the user in advance, the extracting section 17 searches the result of the reading carried out in step S302 for the entered information inputted by the user in advance.

(Step S307)

In step S307, the extracting section 17 extracts the individual feature F1 of the entered information C21 searched for in step S306, and adds, to the group of individual features G2, the individual feature F1 extracted.

(Steps S308 and S309)

In step S308, the calculating section 18 refers to the group of individual features G2 having the individual feature F1 added thereto, to calculate a common feature. In step S309, the calculating section 18 update the common feature F2 with the common feature newly calculated.

After finishing the processing of step S309, the calculating section 18 proceed to the processing of step S204. The processing of steps S204 to S208 is the same as the processing illustrated in FIG. 6 in the second example embodiment, and the description thereof is not repeated.

As above, a configuration employed in the image processing apparatus 1B in accordance with the third example embodiment is that the image processing apparatus 1B includes: a modifying section 16 that modifies the entered information according to a user operation; an extracting section 17 that extracts, from the entered information C21 having been modified, an individual feature which is a feature regarding the entered information C21; a calculating section 18 that refers to a group of individual features having the individual feature F1 added thereto, to calculate the common feature F2, which is a feature of information to be entered into a form of the same format as the form represented by the input image II; and a cutting section 15B that refers to the common feature F2 to cut out the partial image PI from the input image II. Accordingly, the image processing apparatus 1B in accordance with the third example embodiment provides an example advantage of being capable of more accurately reading the entered information having been entered in a form without setting, by a user in advance, of format information regarding an entry column.

A configuration employed in the image processing apparatus 1B in accordance with the third example embodiment is that each of the modifying section 16, the extracting section 17, the calculating section 18, and the cutting section 15B determines whether to carry out the above corresponding processing, according to a similarity between the common feature F2 and the individual feature F3 regarding the entered information read by the reading section 11. Accordingly, the image processing apparatus 1B in accordance with the third example embodiment provides an example advantage of being capable of updating the format information with more appropriate information in a case where a user does not set, in advance, format information regarding an entry column.

### Software Implementation Example

Some or all of the functions of each of the image processing apparatuses 1, 1A, and 1B may be implemented by hardware such as an integrated circuit (IC chip), or may be implemented by software.

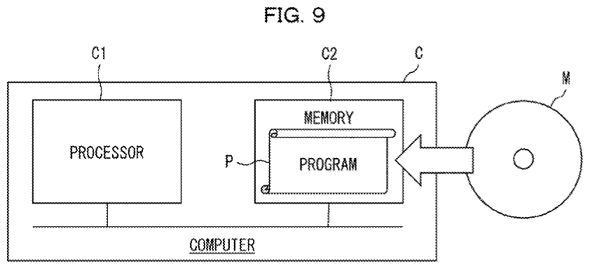

In the latter case, the image processing apparatuses 1, 1A, and 1B are provided by, for example, a computer that executes instructions of a program that is software implementing the foregoing functions. An example (hereinafter, computer C) of such a computer is illustrated in FIG. 9. The computer C includes at least one processor C1 and at least one memory C2. The memory C2 stores a program P for causing the computer C to operate as the image processing apparatuses 1, 1A, and 1B. The processor C1 of the computer C retrieves the program P from the memory C2 and executes the program P, so that the functions of the image processing apparatuses 1, 1A, and 1B are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 can include a flash memory, a hard disk drive (HDD), a solid state drive (SSD), and a combination thereof.

The computer C may further include a random access memory (RAM) in which the program P is loaded when executed and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be stored in a computer C-readable, non-transitory, and tangible storage medium M. Examples of such a storage medium M can include a tape, a disk, a card, a semiconductor memory, and a programmable logic circuit. The computer C can obtain the program P via the storage medium M. Alternatively, the program P can be transmitted via a transmission medium. Examples of such a transmission medium can include a communication network and a broadcast wave. The computer C can also obtain the program P via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

Some or all of the foregoing example embodiments can also be described as below. Note, however, that the present invention is not limited to the following example aspects.

(Supplementary Note 1)

An image processing apparatus including: a reading means for referring to a reference image to read entered information from an input image or a partial image, the reference image representing a blank entry column, the input image representing a target form that contains an entry column, the partial image representing the entry column; a generating means for referring to a group of partial images to generate a new reference image, the group of partial images having the partial image added thereto, the new reference image representing a blank entry column; and an updating means for replacing the reference image with the new reference image for update.

(Supplementary Note 2)

The image processing apparatus described in supplementary note 1, further including a setting means for setting format information regarding the entry column according to a user operation; and a cutting means for referring to the format information to cut out the partial image from the input image.

(Supplementary Note 3)

The image processing apparatus described in supplementary note 2, in which depending on whether a first input image of a series of input images, the first input image being an initial input image of the series of input images, represents a written form or a blank form, the series of input images that represent forms which are of the same format as the target form, each of the cutting means, the generating means, and the updating means determines whether to carry out the above corresponding processing with respect to a second and subsequent input images that included in the series of input images and that follow the first input image.

(Supplementary Note 4)

The image processing apparatus described in supplementary note 1, further including: an modifying means for modifying the entered information according to a user operation; an extracting means for extracting, from the entered information which has been modified, an individual feature which is a feature regarding the entered information; a calculating means for referring to a group of individual features having the individual feature added thereto, to calculate a common feature, which is a feature of information to be entered into a form which is of the same format as the target form; and a cutting means for referring to the common feature to cut out the partial image from the input image.

(Supplementary Note 5)

The image processing apparatus described in supplementary note 4, in which according to a similarity between the common feature and a feature regarding the entered information read by the reading means, each of the modifying means, the extracting means, the calculating means, and the cutting means determines whether to carry out the above corresponding processing.

(Supplementary Note 6)

An image processing method including: at least one processor referring to a reference image to read entered information from an input image or a partial image, the reference image representing a blank entry column, the input image representing a target form that contains an entry column, the partial image representing the entry column; the at least one processor referring to a group of partial images to generate a new reference image, the group of partial images having the partial image added thereto, the new reference image representing a blank entry column; and the at least one processor replacing the reference image with the new reference image.

(Supplementary Note 7)

An image processing program for causing a computer to function as: a reading means for referring to a reference image to read entered information from an input image or a partial image, the reference image representing a blank entry column, the input image representing a target form that contains an entry column, the partial image representing the entry column; a generating means for referring to a group of partial images to generate a new reference image, the group of partial images having the partial image added thereto, the new reference image representing a blank entry column; and an updating means for replacing the reference image with the new reference image.

(Supplementary Note 8)

An image processing apparatus including at least one processor, the at least one processor carrying out: processing of referring to a reference image to read entered information from an input image or a partial image, the reference image representing a blank entry column, the input image representing a target form that contains an entry column, the partial image representing the entry column; processing of referring to a group of partial images to generate a new reference image, the group of partial images having the partial image added thereto, the new reference image representing a blank entry column; and processing of replacing the reference image with the new reference image for update.

Note that this image processing apparatus may further include a memory. This memory may store a program for causing the processor to carry out the processing (a), the processing (b), and the processing (c). This program may be stored in a computer-readable, non-transitory, and tangible storage medium.

### REFERENCE SIGNS LIST

1, 1A, 1B: Image processing apparatus
11: Reading section
12: Generating section
13: Updating section
14: Setting section
15B: Cutting section
16: Modifying section
17: Extracting section
18: Calculating section
S1: Image processing method

1. An image processing apparatus comprising
at least one processor, the at least one processor carrying out:
processing (a) of referring to a reference image to read entered information from an input image or a partial image, the reference image representing a blank entry column, the input image representing a target form that contains an entry column, the partial image representing the entry column;
processing (b) of referring to a group of partial images to generate a new reference image, the group of partial images having the partial image added thereto, the new reference image representing a blank entry column; and
processing (c) of replacing the reference image with the new reference image for update.

2. The image processing apparatus according to claim 1, wherein
the at least one processor further carries out:
processing (d) of setting format information regarding the entry column according to a user operation; and
processing (e) of referring to the format information to cut out the partial image from the input image.

3. The image processing apparatus according to claim 2, wherein
depending on whether a first input image of a series of input images, the first input image being an initial input image of the series of input images, represents a written form or a blank form, the series of input images that represent forms which are of the same format as the target form, the at least one processor determines whether to carry out the processing (e), processing (b), and processing (c) with respect to a second and subsequent input images that included in the series of input images and that follow the first input image.

4. The image processing apparatus according to claim 1, wherein
the at least one processor further carries out:
processing (f) of modifying the entered information according to a user operation;
processing (g) of extracting, from the entered information which has been modified, an individual feature which is a feature regarding the entered information;
processing (h) of referring to a group of individual features having the individual feature added thereto, to calculate a common feature, which is a feature of information to be entered into a form which is of the same format as the target form; and
processing (i) of referring to the common feature to cut out the partial image from the input image.

5. The image processing apparatus according to claim 4, wherein
the at least one processor determines whether to carry out the processing (f), the processing (g), the processing (h), and the processing (i) according to a similarity between the common feature and a feature regarding the entered information read in the processing (a).

6. An image processing method comprising:
at least one processor referring to a reference image to read entered information from an input image or a partial image, the reference image representing a blank entry column, the input image representing a target form that contains an entry column, the partial image representing the entry column;
the at least one processor referring to a group of partial images to generate a new reference image, the group of partial images having the partial image added thereto, the new reference image representing a blank entry column; and
the at least one processor replacing the reference image with the new reference image.

7. A non-transitory storage medium storing a program for causing a computer to carry out:
processing of referring to a reference image to read entered information from an input image or a partial image, the reference image representing a blank entry column, the input image representing a target form that contains an entry column, the partial image representing the entry column;
processing of referring to a group of partial images to generate a new reference image, the group of partial images having the partial image added thereto, the new reference image representing a blank entry column; and
processing of replacing the reference image with the new reference image for update.
